(19) United States
(12) Patent Application Publication
(10) Pub. No.: US 2003/0055961 A1
(43) Pub. Date: Mar. 20, 2003

(54) Network device management apparatus, management system, and management method, and network device

(76) Inventor: Minoru Torii, Tokyo (JP)

Correspondence Address: FITZPATRICK CELLA HARPER & SCINTO, 30 ROCKEFELLER PLAZA, NEW YORK, NY, 10112, US

(21) Appl. No.: 10/238,779

(22) Filed: Sep. 11, 2002

(30) Foreign Application Priority Data
Sep. 20, 2001 (JP) 2001-287553

(51) Int. Cl. G06F 15/173

(52) U.S. Cl. 709/224; 709/220

(57) ABSTRACT

Disclosed is a network device management apparatus by which no timeout occurs even when device discovery over a broad area is requested, and the network traffic for device discovery is little. The network device management apparatus according to this invention includes, in each subnet, a discovery FSA 308 for retrieving and holding device information. A CSB LM 302 for network device management manages the address information of the device discovery FSA 308 present in the network. When device discovery is requested by a client 309, the address information of a device discovery FSA corresponding to the discovery area is returned. The client retrieves device information from each device discovery FSA by using the notified address information.

### FIELD OF THE INVENTION

The present invention relates to the management of a computer network and, more particularly, to an apparatus, system, and method of managing a device (network device) on a network and to the network device.

### BACKGROUND OF THE INVENTION

As a conventional method of managing a network device (a device connected to a computer network), a method using SNMP/MIB (Simple Network Management Protocol/Management Information Base) is available. (Details of this SNMP/MIB are described in “Introduction to TCP/IP Network Management, For Practical Management”, written by M. T. Rose/translated by Takeshi Nishida, issued by TOPPAN PRINTING CO., LTD., Aug. 20, 1992).

In the SNMP network management technology, a network management system includes at least one network management station (NMS), several management target nodes each having an agent, and a network management protocol which the management station and each agent use to exchange management information. A user can obtain or change data on the network by communicating with agent software on a management target node by using network management software on the NMS.

When this network management software is to be used in a distributed environment, the software is generally configured by a server application having a network managing function, and a plurality of client applications each of which is a GUI activated by the corresponding terminal.

In this distributed environment, the client applications and the server application perform inter-process communication between different terminals. As a standard of this inter-process communication, RFC1057 RPC (Remote Procedure Call) is defined. In this RPC, functions for providing network services are prepared by the server, and, similar to an internal function of a local machine, any of these functions can be called from a client process at another terminal on the network.

The flow of inter-process communication in the RPC is as follows. A client calls an RPC function prepared in the server, as a service request to that server. At this timing, a data packet containing function call information is sent to the server, and the program (process) of the client is interrupted. When receiving the packet, the server dispatches the called function, extracts the argument of the function, executes the service on the basis of the argument, and returns the result to the client. The client receives the result of the function and reexecutes the program (process).

One server application having the network managing function described above is installed on a distributed network and manages a plurality of devices by using a plurality of instances in this server application. On the other hand, a plurality of client applications operate at different terminals and access the server application by using the above-mentioned inter-process communication. Each client application retrieves and sets device information via the server application.

As the network managing function, the server application provides a client with a device discovery function for discovering for a network device. From the list of devices found by the server application, a client can retrieve device basic information such as the address and device name of a device to be managed. The server application performs subnet broadcast to discover the devices placed in a plurality of subnets.

FIG. 1 is a view showing the configuration of a computer network which can be an object of network management. In this computer network shown in FIG. 1, three LANs 100, 110, and 120 are connected by modem/transponders 130. Apparatuses such as a printer server apparatus, file server apparatus, and client apparatus and network printers are connected to each of these LANs 100, 110, and 120.

FIG. 2 is a schematic view for explaining a case in which on the LANs 100 and 120 shown in FIG. 1, computer apparatuses 103 and 121 connected to the LAN 100 operate as a client and server apparatus, respectively. Referring to FIG. 2, “DEVICE” is another network device connected to each LAN and means a network printer, computer apparatus, or the like.

In FIG. 2, when a process A of a client application on the PC 103 is to access a process B of a server application on the PC 121 and discover for a device, the client application communicates with the server application by using the function of inter-process communication. Also, the server application performs device discovery by using broadcast of the SNMP protocol.

This device discovery is done in two steps. In the first step, address information of each device is retrieved by broadcast. In the next step, the MIB value of device basic information such as the device name and location is retrieved for each device found by the broadcast.

To perform this device discovery, each client application performs inter-process communication by using a proxy, thereby requesting the server application to perform device discovery. The server application receives information transmitted by the proxy (stub), and performs device discovery by using broadcast of the SNMP protocol or the like. By default settings, the server application discovers the devices present on the subnet LAN 100 on which this server application exists. However, if the client application designates a discovery area exceeding the subset, e.g., if the client application designates device discovery on the LAN 120 shown in FIG. 2, the server application discovers devices by subnet broadcast.

Device list information obtained by the discovery is transmitted from the stub of the server application to the proxy by using inter-process communication, and sent from the proxy to the client application by call back. On the basis of this information notified from the server application by call back, the client application displays the device list information by bit map display or the like.

In the above prior art, however, if the client application of the network management software (server application) designates a subnet having a large number of hops as an object of discovery, responses from devices on the subnet may not be obtained within a predetermined discovery timeout time. In this case, not all devices present on the designated subnet can be discovered.

Also, the retrieval of device basic information after broadcast is performed for each device. This generates unnecessary network traffic in the network between a subnet on which the server application exists and a subnet on which devices exist.

### SUMMARY OF THE INVENTION

The present invention has been made to solve the problems of the above prior art, and has as its object to provide a network device management apparatus, management system, and management method and a network device by which no timeout occurs even when device discovery over a broad area is designated, and network traffic for device discovery is little.

In order to achieve thee above objects, according to the present invention, a management method of managing a network device present on a network, comprising: a transmission step of transmitting to the network a discovery request for requesting discovery of a network device present on the network; a response step of returning, in response to the discovery request, to the transmission source of the discovery request, access information for accessing a device information collecting apparatus for collecting device information concerning a network device present within a predetermined area of the network; and a retrieval step of retrieving, on the basis of the access information, the device information from a device information collecting apparatus corresponding to the access information.

In order to achieve thee above objects, according to the present invention, an information processing method comprising: a reception step of receiving, from the network, a discovery request of requesting discovery of a network device present on the network; and a response step of returning, in response to the discovery request, to the transmission source of the discovery request, access information for accessing a device information collecting apparatus for collecting device information concerning a network device present within a predetermined area of the network.

In order to achieve thee above objects, according to the present invention, an information processing method comprising: a transmission step of transmitting to the network a discovery request for requesting discovery of a network device present on the network; a reception step of receiving access information for accessing a device information collecting apparatus for collecting device information concerning a network device present within a predetermined area of the network; and

a retrieval step of retrieving, on the basis of the access information, the device information from a device information collecting apparatus corresponding to the access information.

In order to achieve thee above objects, according to the present invention, a information processing apparatus comprising: storage means for storing access information for accessing a device information collecting apparatus for collecting device information concerning a network device present within a predetermined area of the network; and responding means for returning the access information to the transmission source of the discovery request in accordance with a discovery request for requesting discovery of a network device present on the network.

In order to achieve thee above objects, according to the present invention, an information processing apparatus comprising: transmitting means for transmitting to the network a discovery request for requesting discovery of a network device present on the network; receiving means for receiving access information for accessing a device information collecting apparatus for collecting device information concerning a network device present within a predetermined area of the network; and retrieving means for retrieving, on the basis of the access information, the device information from a device information collecting apparatus corresponding to the access information.

In order to achieve thee above objects, according to the present invention, a management system for managing a network device present on a network, comprising: a device information collecting apparatus for collecting device information concerning a network device present within a predetermined area of the network; a management apparatus for storing access information for accessing said device information collecting apparatus, and, in response to a discovery request for requesting discovery of a network device present on the network, returning the access information to the transmission source of the discovery request; and an information processing apparatus for transmitting the discovery request, receiving the access information, and, on the basis of this access information, retrieving the device information from a device information collecting apparatus corresponding to the access information.

In order to achieve thee above objects, according to the present invention, a program for managing a network device present on a network, wherein said program allows a computer to execute: a reception step of receiving, from the network, a discovery request for requesting discovery of a network device present on the network; and a response step of returning, in response to the discovery request, to the transmission source of the discovery request, access information for accessing a device information collecting apparatus for collecting device information concerning a network device present within a predetermined area of the network.

In order to achieve thee above objects, according to the present invention, a program for retrieving information concerning a network device present on a network, comprising: a transmission step of transmitting to the network a discovery request for requesting discovery of a network device present on the network; a reception step of receiving access information for accessing a device information collecting apparatus for collecting device information concerning a network device present within a predetermined area of the network; and a retrieval step of retrieving, on the basis of the access information, the device information from a device information collecting apparatus corresponding to the access information.

In order to achieve thee above objects, according to the present invention, a computer-readable recording medium storing the program according to the present invention.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a view showing an example of a computer network;

FIG. 2 is a view showing the relationship between a client application, server application, and device;

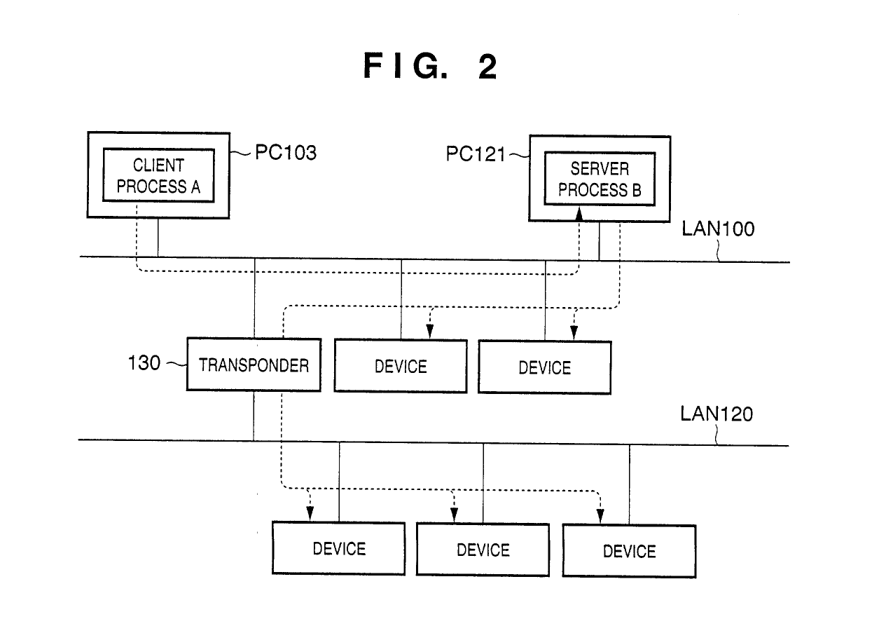

FIG. 3 is a block diagram showing the configuration of a computer apparatus to which the present invention is applicable;

FIG. 4 is a view showing the arrangement of software components in an embodiment of the present invention;

FIG. 5 is a sequence chart showing the operations of a CSB LM and each node (software component) in the embodiment of the present invention;

FIG. 6 is a view showing an example of a device list display;

FIG. 7 is a sequence chart showing the relationship between the operations of individual software components;

FIG. 8 is a flow chart showing the operation of a client software component; and

FIG. 9 is a flow chart showing the operation of a device discovery FSA.

### DETAILED DESCRIPTION OF THE PREFERRED EMBODIMENTS

Preferred embodiments of the present invention will now be described in detail in accordance with the accompanying drawings.

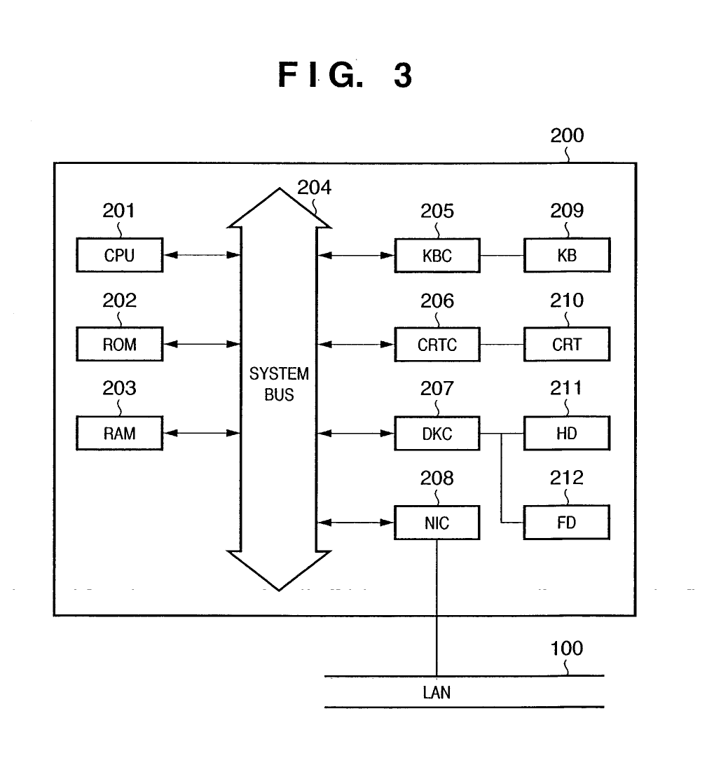

FIG. 3 is a block diagram showing the configuration of a computer apparatus 200 usable as a network device management apparatus, network device, or device information collecting means according to the present invention. The network device management apparatus, network device, or device information collecting means according to the present invention can be implemented by a computer apparatus similar to a computer apparatus which can be implemented by the conventional network device management apparatus.

In this embodiment, network device management according to the present invention is implemented by using the distributed computing technology. In this distributed computing technology, a process of realizing a certain function is distributed to a plurality of hardware, so hardware for actually performing the process is distributed on the network. Hence, the function of the network device management apparatus according to the present invention is actually implemented by a plurality of network devices. However, it should be noted that this specification includes, for the sake of descriptive simplicity, portion describing that a specific apparatus operates as the network device management apparatus.

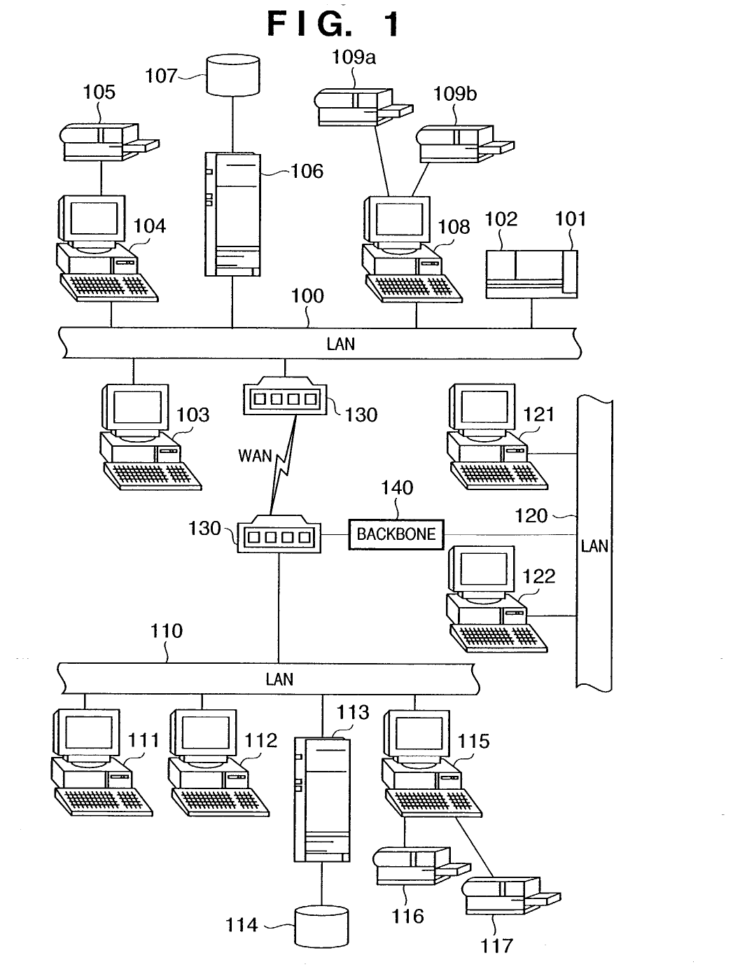

Referring to FIG. 1, a hard disk (HD) 211 stores a program (network management program) for allowing the computer 200 as the network device management apparatus according to this embodiment. In the following explanation, the main component which executes the processing of this network management apparatus is a CPU 201, and the main software of control is the network management software stored in the hard disk (HD) 211. In this embodiment, Windows 98 (Microsoft) is assumed as an OS running on the computer 200 which functions as the network management apparatus. However, another OS can also be used.

The network management program stored in the HD 211 can also be supplied in the form of a storage medium such as a floppy disk or CD-ROM. In this case, the program is read out from the storage medium by a floppy disk driver (FD) 212 shown in FIG. 3 or a CD-ROM driver (not shown), and installed in the hard disk (HD) 211. The network management program can also be supplied across a LAN 100 or another network.

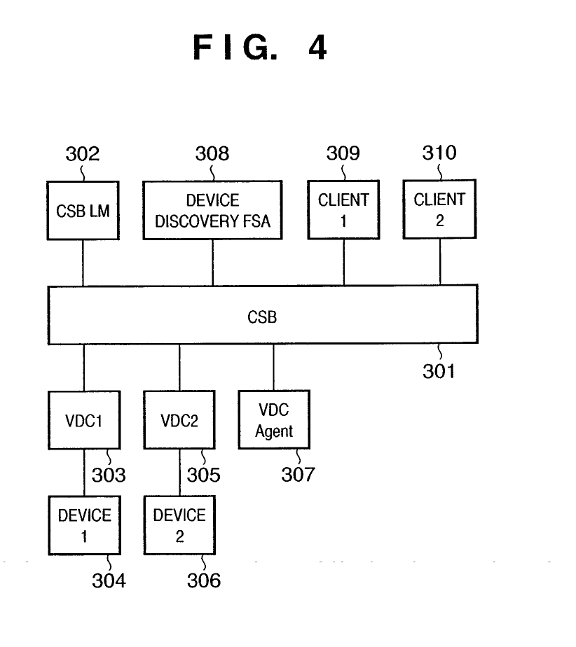

FIG. 4 shows the arrangement of software components in the network on which the network management apparatus according to this embodiment operates. Since the network management apparatus according to this embodiment operates in the distributed environment, a computer apparatus containing the network management software can operate as a network device management apparatus (server) or a network device (client).

Accordingly, FIG. 4 shows both software components (server software components) functioning as so-called servers and software components (client software components) functioning as clients. Also, although a device 1 (304) and device 2 (306) are illustrated in FIG. 4 for the convenience of explanation, they are actually hardware such as printers.

All software components are connected to a logical software bus 301 called CSB. A CSB LM 302 provides a function of distributing messages between software components connected to the CSB. A VDC1 303 is a server software component for managing the device 1 (304). Likewise, a VDC2 305 is a server software component for managing the device 2 (306).

A VDC agent 307 is a software component which manages the address of a device on which the process of each VDC 303 or 305 is running, the interface pointer of each VDC, and basic information (e.g., the device name and address) of a device managed by each VDC. A device discovery FSA 308 is a software component for discovering for devices in the network. A client 1 (309) and client 2 (310) are client software components which use the individual software components described above. These software components can be installed in any accessible terminals on the network.

For example, when the client 1 (309) is to perform device discovery, the client 1 sends a CSB message to the CDB LM 302 via the CSB 301 as a logical bus, and retrieves the class ID of the device discovery FSA 308 and the address of a terminal at which this device discovery FSA 308 is operating. On the basis of the retrieved information, the client 1 (309) retrieves the interface pointer of the device discovery FSA 308.

The client 1 (309) then retrieves a device list from the device discovery FSA. Since this device discovery FSA 308 periodically discovers the devices in its own subnet, the client 1 (309) refers to a cache value held in the device discovery FSA. Details of the operation of this device discovery FSA will be described later.

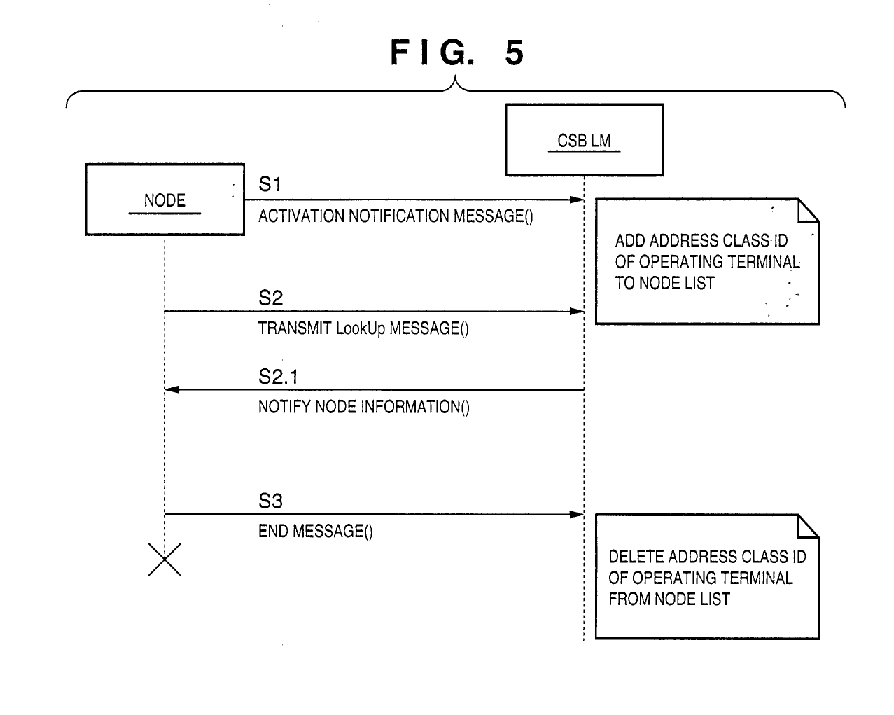

FIG. 5 is a sequence view showing operations performed between a certain software component (node) and the CSB LM from the activation to termination of the node.

In step S1, the node (e.g., the client software component 309) finishes activation and transmits a CSB message indicating the end of activation to the CSB LM 302. The address of this CSB LM 302 can be obtained by using multicast or the like.

On the basis of information contained in the CSB message, the CSB LM 302 adds, to a node list which this CSB LM 302 manages, the address of a terminal at which the newly activated node is operating and the class ID of that node. In step S2, to retrieve, from the CSB LM, information of another node to be accessed as needed by the node 309, the node 309 transmits a CSB LookUp message which contains the class ID and service information of the other node and the address (e.g., the IP address), port number, and the like of a terminal at which the other node is operating. In step S2.1, the CSB LM notifies the required node information. In step S3, a CSB message indicating the termination of the node is transmitted to the CSB LM before the node is actually terminated. In response to this message, the CSM LM deletes information concerning the corresponding node from the node list.

In this manner, the CSB LM always stores and updates information concerning management target nodes in the node list.

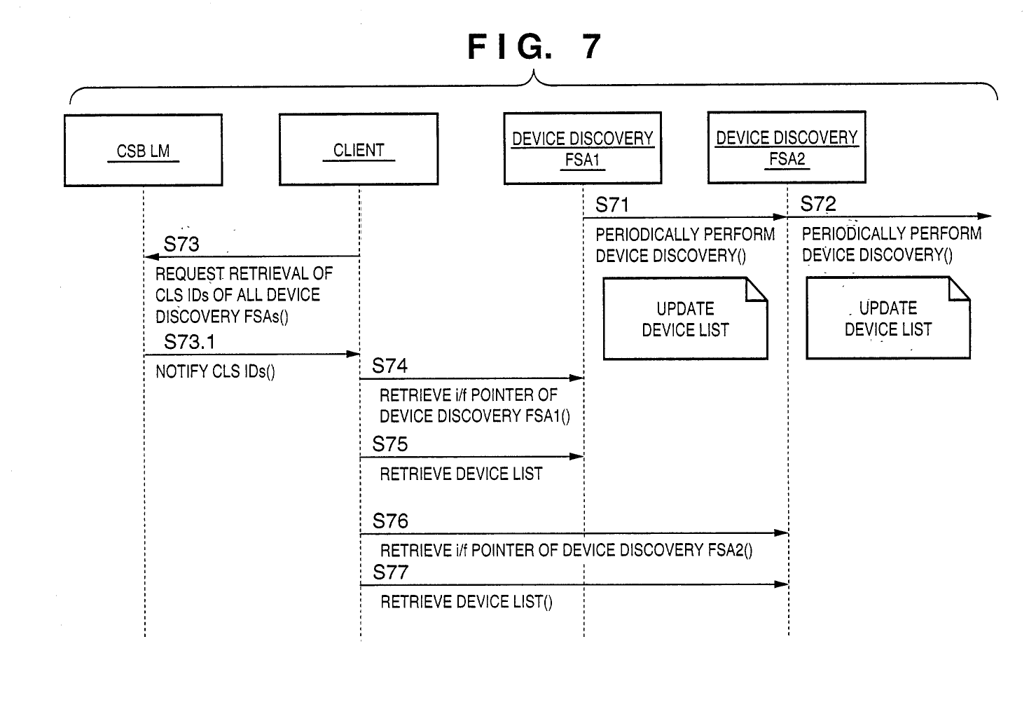

An outline of the operation of each software component when device discovery is performed will be explained below with reference to a sequence chart shown in FIG. 7.

In steps S71 and S72, a device discovery FSA1 and device discovery FSA2 arranged in different subnets periodically perform device discovery in the subnets and update device lists in internal caches.

In step S73, the client requests the CSB LM to retrieve the class IDs of all device discovery FSAs (the device discovery FSA1 and device discovery FSA2) and the addresses of terminals at which these device discovery FSAs are operating. In step S73.1, the CSB LM notifies the client of the class IDs of the device discovery FSA1 and device discovery FSA2 in the network to be managed and the addresses of the terminals at which these device discovery FSAs are operating.

In step S74, the client retrieves the interface pointer of the device discovery FSA1 by using inter-process communication. In step S75, the client retrieves a device list from the device discovery FSA1 by using the interface pointer obtained in step S74. If a plurality of device discovery FSAs are present on the network as shown in FIG. 7, steps S74 and S75 are repeated for each device discovery FSA.

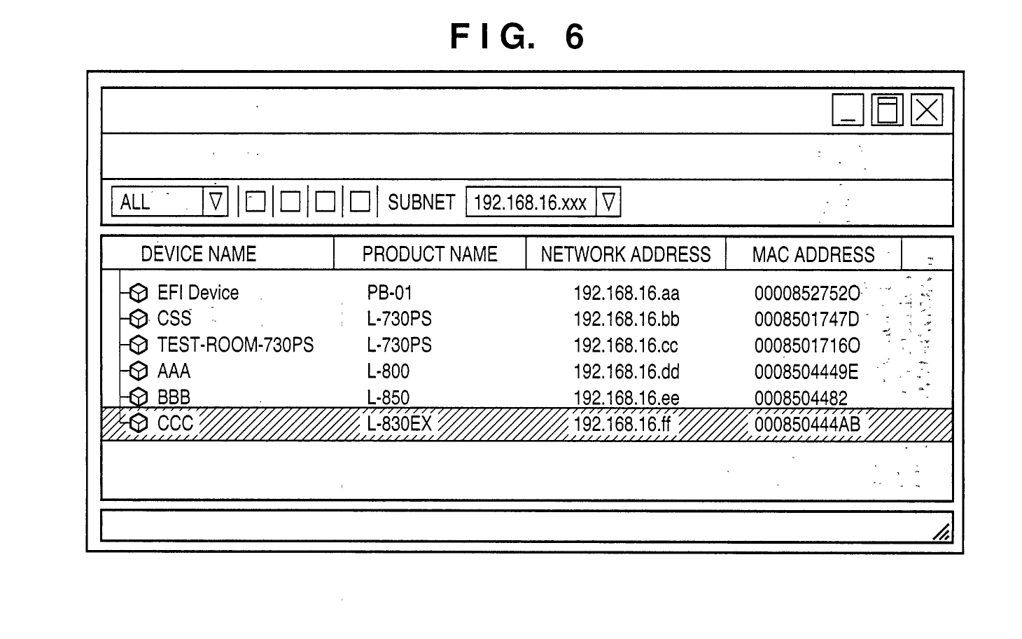

In this example shown in FIG. 7, the two device discovery FSAs are present. Therefore, the client retrieves the interface pointer of the second device discovery FSA2 in step S76, and retrieves a device list in step S77. After that, the client displays a device list of each subnet. FIG. 6 shows an example of the device list display on the client.

In this embodiment, each device discovery FSA periodically discovers only the devices in its own network and always keeps the device list up-to-date. In response to a discovery request from a client, therefore, each device discovery FSA can send information concerning all devices on the subnet within the discovery response waiting time limit. By retrieving device lists from a plurality of discovery FSAs, the client can discover and manage devices over a plurality of subnets. Also, only device list information is exchanged between the client and each device discovery FSA. Accordingly, no unnecessary network traffic is generated in the network between a subnet in which the server application is present and a subnet in which devices are present.

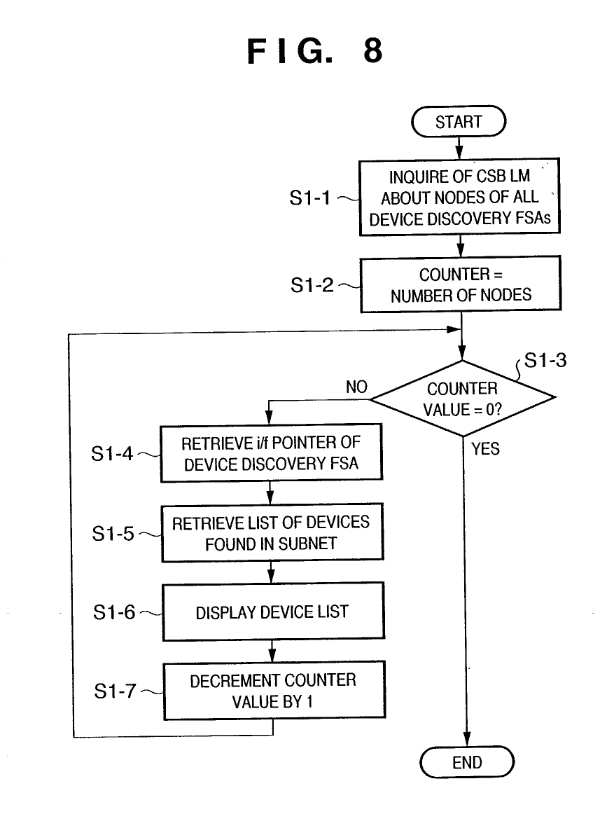

The internal operation of the client software component will be described below with reference to a flow chart in FIG. 8. In step S1-1, the client software component inquires of the CSB LM about the node information (the class ID, and the address of a terminal at which a device discovery FSA is operating) of all device discovery FSAs managed by the CSB LM. In step S1-2, the client software component sets the number of nodes of the retrieved device discovery FSAs in a counter. If in step S1-3 the counter value is 0, the client software component terminates the processing.

If the counter value is not 0, the flow advances to step S1-4, and the client software component retrieves the interface pointer of the device discovery FSA. In step S1-5, the client software component retrieves from the device discovery FSA a list of devices found in its own subnet. In step S1-6, the client software component displays the device list. In step S1-7, the client software component decrements the counter value by 1.

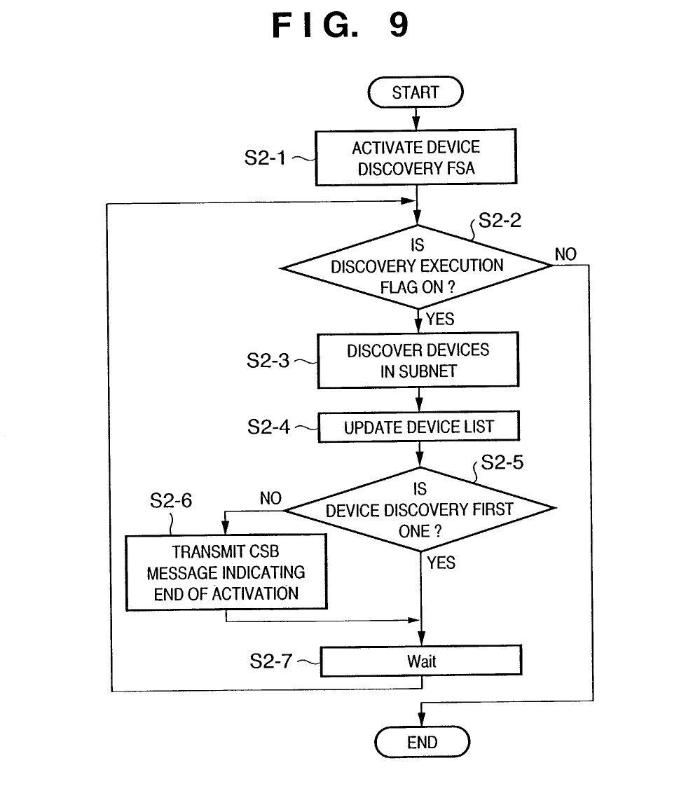

The internal operation of the device discovery FSA will be explained with reference to a flow chart in FIG. 9. In step S2-1, the device discovery FSA is activated. If in step S2-2 a discovery execution flag is OFF, the device discovery FSA terminates the processing. If this discovery execution flag is ON, the flow advances to step S2-3, and the device discovery FSA discovers the devices in its own subnet. The discovery execution flag is set to OFF if the management application which manages activation and termination of the device discovery FSA stops device discovery and terminates the device discovery FSA.

In step S2-4, the device discovery FSA updates the device list as an internal cache. If in step S2-5 this device discovery is the first one, the flow advances to step S2-6, and the device discovery FSA transmits a CSB message indicating that the activation of the device discovery FSA is terminated and the cache value of the device list is effective. If this device discovery is not the first one, the flow advances to step S2-7, and the device discovery FSA waits for a predetermined period. After that, the flow advances to step S2-3, and the device discovery FSA reexecutes device discovery, thereby periodically updating the device list.

In the above embodiment, the network device management apparatus according to the present invention is implemented by using the distributed computing technology. However, the general client-server type network technology can also be used. In this case, the server software component is implemented by a server apparatus, and the client software component is implemented by a client apparatus. The function corresponding to the device discovery FSA can be implemented by a dedicated discovery server apparatus of each subnet or given to an arbitrary device on the network.

Further, the object of the present invention can also be achieved by supplying a storage medium (or recording medium) storing program codes of software for implementing the functions of the above embodiment to a system or apparatus, and reading out and executing the program codes stored in the storage medium by a computer (or a CPU or MPU) of the system or apparatus. In this case, the program codes read out from the storage medium implement the functions of the present invention, and these program codes and the storage medium storing the program codes constitute the invention. Furthermore, besides the functions of the above embodiment are implemented by executing the readout program codes by the computer, the present invention includes a case where an OS (Operating System) or the like running on the computer performs part or the whole of actual processing in accordance with designations by the program codes and thereby implements the functions of the above embodiments.

Furthermore, the present invention also includes a case where the program codes read out from the storage medium are written in a memory of a function extension card inserted into the computer or of a function extension unit connected to the computer, and, in accordance with designations by the program codes, a CPU or the like of the function extension card or function extension unit performs part or the whole of actual processing and thereby implements the functions of the above embodiment.

When the present invention is applied to the storage medium described above, this storage medium stores program codes corresponding to the flow charts (at least one of FIGS. 5 and 7 to 9) explained previously.

As has been described above, in the network device distributed control apparatus and method according to the present invention, when a client application of network management software requests device discovery on a subnet having a large number of hops, a device list is retrieved from a device discovery FSA installed in the subnet. This effectively allows the client to discover all devices exceeding the subnet as an object of management.

Also, the retrieval of device basic information after broadcast is performed between a device discovery FSA installed in each subnet and devices present on the subnet. This effectively prevents the generation of unnecessary network traffic in the network between a subnet in which the server application is present and a subnet in which the devices are present.

Furthermore, the present invention can be applied to the system comprising either a plurality of units or a single unit. It is needless to say that the present invention can be applied to the case which can be attained by supplying programs which execute the process defined by the present system or invention.

What is claimed is:

1. A management method of managing a network device present on a network, comprising:
a transmission step of transmitting to the network a discovery request for requesting discovery of a network device present on the network;
a response step of returning, in response to the discovery request, to the transmission source of the discovery request, access information for accessing a device information collecting apparatus for collecting device information concerning a network device present within a predetermined area of the network; and
a retrieval step of retrieving, on the basis of the access information, the device information from a device information collecting apparatus corresponding to the access information.

2. The method according to claim 1, wherein
the response step comprises returning a plurality of pieces of access information, and
the retrieval step comprises retrieving device information from a plurality of device information collecting apparatuses which each of the plurality of pieces of access information corresponds to.

3. The method according to claim 1, further comprising a display step of displaying the device information retrieved in the retrieval step.

4. The method according to claim 1, wherein the device information collecting apparatus has the collection step of periodically collecting or updating the device information.

5. The method according to claim 1, wherein the device information collecting apparatus is installed in each subnet which constitutes the network, and collects device information of a network device present in the subnet.

6. The method according to claim 1, wherein the retrieval step comprises:
retrieving, by using inter-process communication, a pointer to a device information collecting process of collecting the device information; and
retrieving device information from the device information collecting process by using the retrieved pointer.

7. An information processing method comprising:
a reception step of receiving, from the network, a discovery request of requesting discovery of a network device present on the network; and
a response step of returning, in response to the discovery request, to the transmission source of the discovery request, access information for accessing a device information collecting apparatus for collecting device information concerning a network device present within a predetermined area of the network.

8. An information processing method comprising:
a transmission step of transmitting to the network a discovery request for requesting discovery of a network device present on the network;
a reception step of receiving access information for accessing a device information collecting apparatus for collecting device information concerning a network device present within a predetermined area of the network; and
a retrieval step of retrieving, on the basis of the access information, the device information from a device information collecting apparatus corresponding to the access information.

9. A information processing apparatus comprising:
storage means for storing access information for accessing a device information collecting apparatus for collecting device information concerning a network device present within a predetermined area of the network; and
responding means for returning the access information to the transmission source of the discovery request in accordance with a discovery request for requesting discovery of a network device present on the network.

10. An information processing apparatus comprising:
transmitting means for transmitting to the network a discovery request for requesting discovery of a network device present on the network;
receiving means for receiving access information for accessing a device information collecting apparatus for collecting device information concerning a network device present within a predetermined area of the network; and
retrieving means for retrieving, on the basis of the access information, the device information from a device information collecting apparatus corresponding to the access information.

11. A management system for managing a network device present on a network, comprising:
a device information collecting apparatus for collecting device information concerning a network device present within a predetermined area of the network;
a management apparatus for storing access information for accessing said device information collecting apparatus, and, in response to a discovery request for requesting discovery of a network device present on the network, returning the access information to the transmission source of the discovery request; and
an information processing apparatus for transmitting the discovery request, receiving the access information, and, on the basis of this access information, retrieving the device information from a device information collecting apparatus corresponding to the access information.

12. A program for managing a network device present on a network, wherein said program allows a computer to execute:
a reception step of receiving, from the network, a discovery request for requesting discovery of a network device present on the network; and
a response step of returning, in response to the discovery request, to the transmission source of the discovery request, access information for accessing a device information collecting apparatus for collecting device information concerning a network device present within a predetermined area of the network.

13. A program for retrieving information concerning a network device present on a network, comprising:
a transmission step of transmitting to the network a discovery request for requesting discovery of a network device present on the network;
a reception step of receiving access information for accessing a device information collecting apparatus for collecting device information concerning a network device present within a predetermined area of the network; and
a retrieval step of retrieving, on the basis of the access information, the device information from a device information collecting apparatus corresponding to the access information.

14. A computer-readable recording medium storing the program according to claim 12.

15. A computer-readable recording medium storing the program according to claim 13.
